(19) United States
(12) Patent Application Publication
(10) Pub. No.: US 2020/0249019 A1
(43) Pub. Date: Aug. 6, 2020

(54) ATTACHABLE-DETACHABLE UNIT AND SENSOR CALIBRATING METHOD USING THE SAME

(71) Applicant: PRODRONE CO., LTD., Nagoya-shi, Aichi (JP)

(72) Inventor: Kiyokazu SUGAKI, Nagoya-shi (JP)

(73) Assignee: PRODRONE CO., LTD., Nagoya-shi, Aichi (JP)

(21) Appl. No.: 16/336,853

(22) PCT Filed: Aug. 21, 2017
(86) PCT No.: PCT/JP2017/029717

§ 371 Date: Mar. 26, 2019

(30) Foreign Application Priority Data
Oct. 13, 2016 (JP) 2016-201855

(51) Int. Cl. G01C 17/38; G01C 17/02; G01C 21/12; B64C 39/02; B64D 47/00

(52) U.S. Cl. CPC G01C 17/38; G01C 17/02; B64C 2201/027; B64C 39/024; B64D 47/00; G01C 21/12

(57) ABSTRACT

An attachable-detachable unit and a sensor calibrating method using the same such that the attachable-detachable unit and the sensor calibrating method make calibration work on sensors of an unmanned aerial vehicle efficient and unitize the control functions of the unmanned aerial vehicle. The problem is solved by: an attachable-detachable unit including a base made of a case or a board that is attachable and detachable to and from an airframe of an unmanned aerial vehicle, wherein a magnetic sensor constituting an electronic compass is mounted on the base; and a sensor calibrating method including a procedure for calibrating the electronic compass and/or the inertia measurement device by, with the attachable-detachable unit removed from the unmanned aerial vehicle, manually rotating the attachable-detachable unit or manually keeping the attachable-detachable unit at a predetermined posture.

### TECHNICAL FIELD

The present invention relates to an unmanned aerial vehicle technique.

### BACKGROUND ART

Conventional small-size unmanned aerial vehicles represented by industrial unmanned helicopters have had airframes too expensive to be affordable. Also, these vehicles used to require skillful pilotage for stable flight. In recent years, however, there have been improvements and cost reductions in sensors and software used to control posture of unmanned aerial vehicles and to implement autonomous flight of unmanned aerial vehicles. This has led to considerable improvement in manipulability of unmanned aerial vehicles. In particular, small size multi-copters are simpler in rotor structure than helicopters and thus easier to design and maintain. As such, small size multi-copters are not only used for hobbyist purposes but also applied to various missions in a wide range of fields.

Patent literature 1 below discloses: a problem encountered at the time of detecting directions using geomagnetic sensors provided in mobile phones; and a calibration method for a geomagnetic sensor.

### CITTION LIST

### Cited Literature

PTL1: JP 2006-47299A

### SUMMARY OF INVENTION

### Technical Problem

In order to calibrate sensors, such as an electronic compass, provided in a multi-copter for hobbyist purposes, it is common practice to manually raise the airframe of the multi-copter before a flight and perform calibration work. In this calibration work, the sensors are usually calibrated by: placing the airframe of the multi-copter on a horizontal surface and causing the sensors to recognize this posture as a basic posture of the multi-copter; causing the multi-copter to take a predetermined posture for a predetermined period of time; causing the multi-copter to rotate horizontally with the multi-copter taking the basic posture; causing the airframe of the multi-copter to rotate in a horizontal direction with the nose direction of the airframe of the multi-copter oriented in a vertical direction; and/or causing the airframe to rotate in a vertical direction with the nose direction of the airframe of the multi-copter oriented in a horizontal direction. This manner of calibration would work without any problems if the size and weight of an unmanned aerial vehicle are of such levels that the unmanned aerial vehicle can be raised by a single human being. If, however, the above manner of calibration is applied to, for example, a large size industrial unmanned aerial vehicle, it is necessary to use a few to several human beings to raise the airframe, resulting in large-scale calibration work.

Also conventionally, a control device and sensors that serve as a controller are independently mounted on the frame of an unmanned aerial vehicle. This has made it difficult to: relocate the controller of one airframe to another airframe; and/or to carry the controller alone for tuning purposes.

In light of the above-described problems, a problem to be solved by the present invention is to provide an attachable-detachable unit and a sensor calibrating method using the same such that the attachable-detachable unit and the sensor calibrating method make calibration work on sensors of an unmanned aerial vehicle efficient and unitize the control functions of the unmanned aerial vehicle.

### Solution to Problem

In order to solve the above-described problem, an attachable-detachable unit according to the present invention includes a base including a case or a board that is attachable and detachable to and from an airframe of an unmanned aerial vehicle. A magnetic sensor constituting an electronic compass is mounted on the base.

Before an unmanned aerial vehicle makes a flight, sensors such as a magnetic sensor are calibrated. This is for the purpose of identifying the orientation and/or posture of the airframe indicated by values output from the sensors. Specifically, in actual situations, it is not necessary to move the entire airframe of the unmanned aerial vehicle for calibration purposes; for example, when the direction of the electronic compass is calibrated, it suffices that the components of the electronic compass be moved. In the present invention, a magnetic sensor constituting the electronic compass is attachable and detachable to and from the airframe of the unmanned aerial vehicle. This configuration ensures that a calibration is performed using a minimum number of parts, even when the calibration is performed on an electronic compass of, for example, a large size unmanned aerial vehicle. This makes the calibration work on the electronic compass efficient.

Also, an acceleration sensor and/or an angular velocity sensor are preferably further mounted on the base.

In addition to the electronic compass, an acceleration sensor and/or an angular velocity sensor are mounted on the base. This makes the calibration work on the acceleration sensor and/or the angular velocity sensor efficient, similarly to the electronic compass. Also, values output from the acceleration sensor and the angular velocity sensor can be utilized in the calibration work on the electronic compass. This increases the accuracy of calibration of the electronic compass. It is to be noted that the acceleration sensor and/or the angular velocity sensor may constitute part of an inertia measurement device.

Also, all peripheral devices necessary for calibrating the electronic compass are preferably mounted on the base.

In addition to the electronic compass, all of the configuration necessary for calibrating the electronic compass is mounted on the base, the configuration including a signal processor for the electronic compass and peripheral hardware and/or software. This ensures that the calibration work on the electronic compass is complete using the attachable-detachable unit alone.

Also, a control device, the inertia measurement device, and the electronic compass constitute a flight controller of the unmanned aerial vehicle and may be mounted on the base.

Thus, an essential configuration of a flight control system of the unmanned aerial vehicle is mounted on the base. This realizes unitization of the control functions of the unmanned aerial vehicle. This ensures that the control function of one airframe can be relocated to another airframe, and that the attachable-detachable unit can be carried for tuning purposes.

Also, the attachable-detachable unit according to the present invention preferably includes a battery configured to supply electric power to electronic devices mounted on the base.

Thus, the attachable-detachable unit has its own battery. This enables the attachable-detachable unit to perform calibration work on the sensors without supply of electric power from a battery provided in the airframe to the attachable-detachable unit.

Also, the attachable-detachable unit according to the present invention preferably includes a terminal through which electronic devices mounted on the base are electrically connected to an instrument provided in the airframe of the unmanned aerial vehicle. The terminal preferably includes: a signal line connector to which a signal line of the instrument provided in the unmanned aerial vehicle is connectable; and an electric power line connector to which an electric power line through which electric power is supplied to the electronic devices mounted on the base is connectable.

Thus, a single connector is used to connect the airframe with the signal lines and electric power lines of the electronic devices fixed to the base. This makes the work of attaching and/or detaching the attachable-detachable unit efficient.

Also, in order to solve the above-described problem, a sensor calibrating method according to the present invention includes a procedure for calibrating the electronic compass and/or the inertia measurement device by, with the attachable-detachable unit removed from the unmanned aerial vehicle, manually rotating the attachable-detachable unit or manually keeping the attachable-detachable unit at a predetermined posture.

Thus, the sensors are calibrated before the attachable-detachable unit is mounted on the unmanned aerial vehicle. This ensures that a calibration is performed using a minimum number of parts, even when the calibration is performed on the sensors of, for example, a large size unmanned aerial vehicle. This makes the calibration work on the sensors efficient.

### Advantageous Effects of Invention

Thus, the attachable-detachable unit according to the present invention and the sensor calibrating method using the same make calibration work on sensors of an unmanned aerial vehicle efficient and unitize the control functions of the unmanned aerial vehicle.

### BRIEF DESCRIPTION OF DRAWINGS

FIG. 1 is a perspective view of an exterior of a multi-copter with an attachable-detachable unit mounted on the multi-copter.

FIG. 2 is a perspective view of an exterior of the attachable-detachable unit.

FIG. 3 is a block diagram illustrating a functional configuration of the multi-copter.

### DESCRIPTION OF EMBODIMENTS

[Configuration Summary]

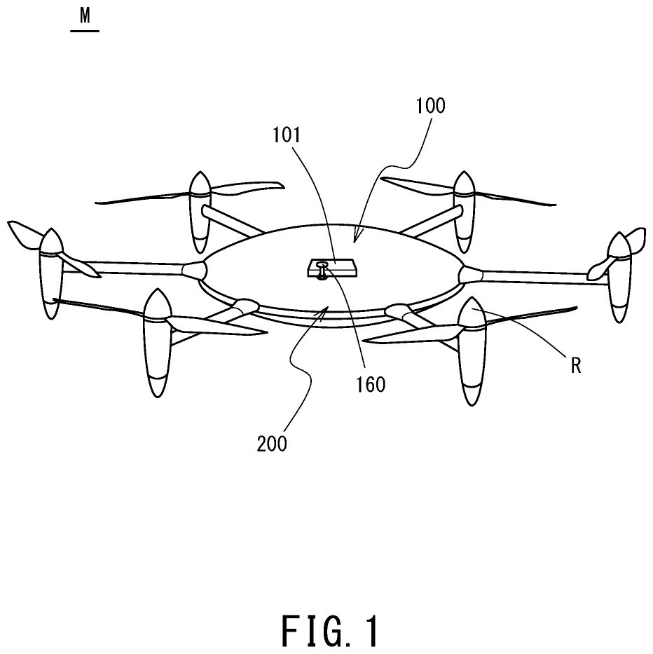

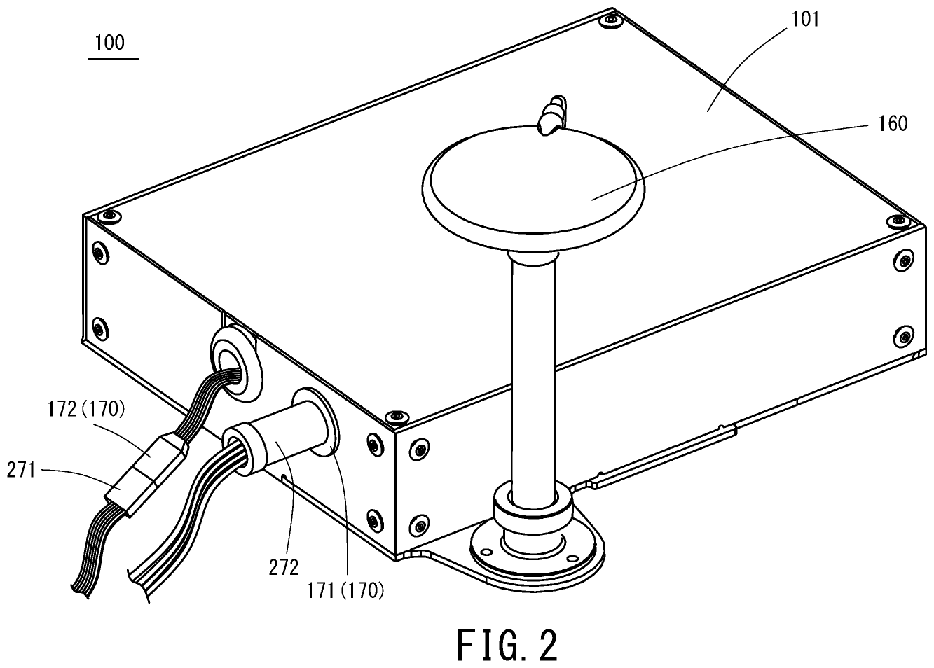

An embodiment of the present invention will be described by referring to the accompanying drawings. FIG. 1 is a perspective view of an exterior of a multi-copter M with an attachable-detachable unit 100 according to the present invention mounted on the multi-copter M. FIG. 2 is a perspective view of an exterior of the attachable-detachable unit 100.

The multi-copter M is an unmanned aerial vehicle that includes six rotors R, which are rotary wings. The attachable-detachable unit 100 includes a case 101 (base), which is attachable and detachable to and from a body 200, which is the airframe of the multi-copter M. In this embodiment, the attachable-detachable unit 100 is mounted at an upper portion of the body 200. There is no particular limitation to the method of mounting the attachable-detachable unit 100 on the body 200; it is possible to use any mounting means under the conditions that the attachable-detachable unit 100 is attachable to the body 200 without rattling and detachable from the body 200. Also, the position at which the attachable-detachable unit 100 is mounted on the body 200 will not be limited to an upper portion of the body 200; the attachable-detachable unit 100 may be mounted at any other portion of the body 200, such as a lower portion and a side portion, to which the attachable-detachable unit 100 can be fixed.

The case 101 of the attachable-detachable unit 100 contains various electronic devices, described later. These electronic devices are fixed to an inside portion of the case 101. Also, as illustrated in FIG. 2, a GNSS receiver 160, which is a part of the electronic devices, is fixed to an outside portion of the case 101. As used in the present invention, the term “electronic device” refers to any kind of device utilizing electronic technology.

Also, terminals 170 are exposed on an outside portion of the case 101. Through the terminals 170, the electronic devices contained in the attachable-detachable unit 100 are electrically connected to the instruments provided in the body 200. The terminals 170 include: one signal line connector 171, which is a connector binding together signal lines of the electronic devices of the attachable-detachable unit 100; and one electric power line connector 172, which is a connector binding together electric power lines of the electronic devices. On the body 200 side, a signal line connector 271 and an electric power line connector 272 are provided, which are connectors corresponding to the respective terminals 170. Thus, the plurality of signal lines and electric power lines of the attachable-detachable unit 100 according to this embodiment are connectable to the body 200 through the single connector 171 and the single connector 172. This makes the work of attaching and detaching the attachable-detachable unit 100 to and from the body 200 efficient.

It is to be noted that the method of connecting the electronic devices contained in the attachable-detachable unit 100 to the instruments on the body 200 side will not be limited to the method using the connectors 171 and 172 according to this embodiment. For example, it is possible to use near-field wireless communication means to send and receive signals between the attachable-detachable unit 100 and the body 200. This eliminates the need for the work of connecting signal lines. As used herein, the term “near-field wireless communication means” encompasses not only electric wave communication means but also optical communication means. It is to be noted that when near-field wireless communication means is employed in the sending and receipt of signals, it is necessary to maintain a balance between communication speed and data reliability, in order to prevent undermining of the functions of the electronic devices of the attachable-detachable unit 100 due to a communication delay.

Also, it is possible to use non-contact power transmit means, such as of electromagnetic induction method and magnetic resonance method, to supply electric power from an electric power source provided in the body 200 to the electronic devices of the attachable-detachable unit 100. This configuration eliminates the need for the work of connecting electric power lines. AC magnetic fields are less influential to geomagnetism. Therefore, it is easier to eliminate the influence that AC magnetic fields have on an electronic compass C, described later. In particular, the magnetic resonance method involves high frequency bands and thus makes it even easier to block electromagnetism.

[Function Configuration]

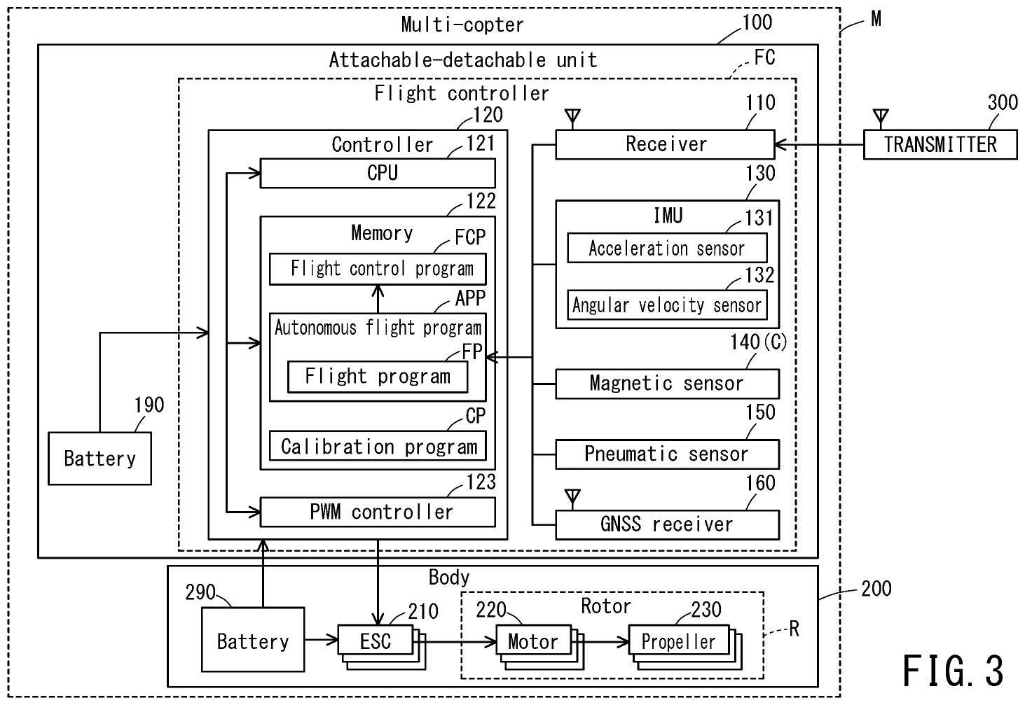

FIG. 3 is a block diagram illustrating a functional configuration of the multi-copter M. The functions of the multi-copter M mainly include: a flight controller FC; the six rotors R; an ESC 210 (Electric Speed Controller), which controls rotation of the rotors R; and a battery 290, which supplies power to the foregoing elements.

Each of the rotors R includes a motor 220 and a propeller 230, which is connected to the output shaft of the motor 220 and has a fixed pitch. The ESC 210 is connected to the motor 220 of the rotor R and rotates the motor 220 at a speed specified by the flight controller FC. There is no particular limitation to the number of rotors of the multi-copter M; the number of rotors may be determined considering required flight stability, cost tolerated, and other considerations. As necessary, the multi-copter M may be changed to: a helicopter, which has two rotors R (a tail rotor is counted as a rotor R); an octocopter, which has eight rotors R; and even a multi-copter having more than eight rotors R.

The flight controller FC includes a controller 120, which is a micro-controller. The controller 120 includes: a CPU 121, which is a central processing unit; a memory 122, which is a storage such as ROM, RAM, and flash memory; and a PWM (Pulse Width Modulation) controller 123, which controls the number of rotations of each motor 220 through the ESC 210.

The flight controller FC further includes: an IMU 130, which is an inertia measurement device; a magnetic sensor 140, which is a three-axis geomagnetic sensor constituting the electronic compass C; a pneumatic sensor 150; and the GNSS receiver 160 (these will be hereinafter occasionally referred to as “sensors”). These sensors are connected to the controller 120. The IMU 130 mainly includes a three-axis acceleration sensor 131 and an angular velocity sensor 132. The GNSS receiver 160 is a Navigation Satellite System (NSS) receiver. The GNSS receiver 160 obtains present longitude and latitude values and present time information from the Global Navigation Satellite System (GNSS) or the Regional Navigation Satellite System (RNSS). The pneumatic sensor 150 is one embodiment of altitude sensor to measure flight altitude. The pneumatic sensor 150 identifies the flight altitude of the multi-copter M by converting a detected air pressure value into a relative altitude relative to the sea level altitude or the take off point of the multi-copter M. The controller 120 is capable of obtaining, from these sensors, how much the airframe is inclined or turning, latitude and longitude of the airframe on flight, altitude, and position information of the airframe including nose azimuth.

The memory 122 of the controller 120 stores a flight control program FCP, which is a program for controlling the posture of the multi-copter M during flight and controlling basic flight operations. In response to an instruction from an operator (transmitter 300), the flight control program FCP adjusts the number of rotations of each rotor R based on information obtained from the sensors so as to correct the posture and/or position of the airframe while the multi-copter M is making a flight.

The multi-copter M may be manipulated by the operator manually using the transmitter 300. Another possible example is to: register a flight plan FP in an autonomous flight program APP in advance, the flight plan FP including parameters such as flight path, speed, and altitude of the multi-copter M; and cause the multi-copter M to fly autonomously to a destination (this kind of autonomous flight will be hereinafter referred to as “autopilot”).

In this embodiment, only the rotors R, the ESC 210, and the battery 290 are provided in or on the body 200 of the multi-copter M. On the attachable-detachable unit 100 side, all the flight control devices are provided, the central device being the flight controller FC. In this manner, an attempt is made to unitize the control function of the multi-copter M, ensuring that the control function of one airframe (the attachable-detachable unit 100) can be relocated to another airframe, and that the attachable-detachable unit 100 alone can be carried for tuning or function adjusting purposes.

It is to be noted that while the multi-copter M according to this embodiment has high-level flight control functions as described above, the unmanned aerial vehicle according to the present invention may be any airframe that includes a plurality of rotors R and the attachable-detachable unit according to the present invention; for example, the unmanned aerial vehicle according to the present invention may be an airframe with some of the sensors omitted or an airframe without autopilot function and capable of flying only by manual manipulation.

[Attachable-Detachable Unit]

The multi-copter M in this example needs to undergo calibration work on the electronic compass C before a flight in order to calibrate directions indicated by the electronic compass C. The multi-copter M is a comparatively large size airframe. In order to rotate the multi-copter M together with the body 200, it is necessary to use a few to several human beings to raise the airframe, resulting in large-scale calibration work. In this embodiment, the attachable-detachable unit 100 contains the magnetic sensor 140, which constitutes the electronic compass C. This ensures that the attachable-detachable unit 100 can be removed from the body 200 so that the attachable-detachable unit 100 alone can undergo the calibration work, making the calibration work efficient. This also applies to the calibration work on the IMU 130.

Also, the attachable-detachable unit 100 contains the IMU 130, as well as the electronic compass C. The acceleration sensor 131 and the angular velocity sensor 132, which are included in the IMU 130, are also used to calibration processing on the electronic compass C. Using the IMU 130, which constitutes the flight controller FC, in the calibration processing on the electronic compass C eliminates the need for an acceleration sensor and/or an angular velocity sensor dedicated to calibration. This improves the accuracy and efficiency of the calibration processing without an increase in piece-part count.

The memory 122 of the controller 120 stores a calibration program CP, which is a program that processes signals associated with the electronic compass C and the IMU 130 at the time of calibration so as to calibrate directions indicated by the electronic compass C. Further, the attachable-detachable unit 100 is provided with a battery 190. The battery 190 is a battery capable of supplying electric power to the electronic devices contained in the attachable-detachable unit 100.

Thus, the attachable-detachable unit 100 according to this embodiment not only includes the electronic compass C but also collectively includes peripheral devices necessary for the calibration work on the electronic compass C, such as the IMU 130, the controller 120, and the calibration program CP. Further, the attachable-detachable unit 100 includes the battery 190, which supplies electric power to these electronic devices. This ensures that the attachable-detachable unit 100 can be removed from the body 200 so that the calibration work on the electronic compass C is complete using the attachable-detachable unit 100 alone. It is to be noted that the phrase “all peripheral devices necessary for calibrating the electronic compass C”, as used in the present invention, means all the hardware and software used in the calibration work on the electronic compass C.

[Sensor Calibrating Method]

Calibrating the electronic compass C in this example includes: first, with the magnetic sensor 140 kept horizontal, horizontally rotating the attachable-detachable unit 100; and then, with the nose of the airframe of the magnetic sensor 100 pointed in a vertically downward direction, horizontally rotating the attachable-detachable unit 100. Also, calibrating the IMU 130 includes: holding the IMU 130 for a predetermined period of time with the IMU 130 kept horizontal; and then, holding the attachable-detachable unit 100 for a predetermined period of time with the IMU 130 kept in such a posture that the nose of the airframe of the IMU 130 pointed in a horizontal direction and in a vertical direction. It is to be noted that the calibration work on the electronic compass C and the calibration work on the IMU 130 will not be limited to the above-described example procedures; the procedures may vary depending on product specifications of the sensors and/or specifications of firmware.

As described earlier, the above-described calibration works are performed with the attachable-detachable unit 100 removed from the multi-copter M. This ensures that even when a large size multi-copter M is about to fly, the calibration work on the electronic compass C and the calibration work on the IMU 130 are performed using a minimum number of parts, making the calibration work on these sensors efficient.

[Modifications]

As described above, the attachable-detachable unit 100 according to this embodiment collectively includes the electronic compass C, the peripheral devices necessary for the calibration work on the electronic compass C, and even the entire configuration of the flight control function of the multi-copter M. This realizes both enhanced efficiency of the calibration work on the electronic compass C and unitization of the control function of the multi-copter M.

In this respect, even if the magnetic sensor 140 alone, which constitutes the electronic compass C, is fixed to the attachable-detachable unit 100, the efficiency of the calibration work can be enhanced. Also, the form of the base to which the magnetic sensor 140 is fixed will not be limited to the case 101; under the condition that the magnetic sensor can be fixed to the base, the base may be, for example, a small size board that is insertable and removable into and out of a slot provided on the body 200. Also, the magnetic sensor 140, which constitutes the electronic compass C, will not be limited to a three-axis geomagnetic sensor; use of a two-axis geomagnetic sensor is also contemplated. Further, the attachable-detachable unit according to the present invention will find applications not only in unmanned rotary-wing aerial vehicles, such as the multi-copter M, but also in: unmanned aerial vehicles with fixed wings; and unmanned airships with propelling power sources.

1. An attachable-detachable unit comprising a base comprising a case or a board that is attachable and detachable to and from an airframe of an unmanned aerial vehicle,
wherein a magnetic sensor constituting an electronic compass is mounted on the base, and
wherein the attachable-detachable unit is removable from the unmanned aerial vehicle before the unmanned aerial vehicle flies so that the electronic compass is calibrated on-site.

2. The attachable-detachable unit according to claim 1, wherein an acceleration sensor and/or an angular velocity sensor are further mounted on the base.

3. The attachable-detachable unit according to claim 2, wherein an inertia measurement device comprising the acceleration sensor and the angular velocity sensor is mounted on the base.

4. The attachable-detachable unit according to claim 1, wherein all peripheral devices necessary for calibrating the electronic compass are mounted on the base.

5. The attachable-detachable unit according to claim 3, wherein a control device, the inertia measurement device, and the electronic compass constitute a flight controller of the unmanned aerial vehicle and are mounted on the base.

6. The attachable-detachable unit according to claim 1, comprising an own battery configured to supply electric power to electronic devices mounted on the base.

7. The attachable-detachable unit according to claim 1, comprising a terminal through which electronic devices mounted on the base are electrically connected to an instrument provided in the airframe of the unmanned aerial vehicle, the terminal comprising:
a signal line connector to which a signal line of the instrument provided in the unmanned aerial vehicle is connectable; and
an electric power line connector to which an electric power line through which electric power is supplied to the electronic devices mounted on the base is connectable.

8. A sensor calibrating method using the attachable-detachable unit according to claim 1, the sensor calibrating method comprising a procedure for calibrating the electronic compass and/or the inertia measurement device by, with the attachable-detachable unit removed from the unmanned aerial vehicle, manually rotating the attachable-detachable unit or manually keeping the attachable-detachable unit at a predetermined posture.

9. A sensor calibrating method using the attachable-detachable unit according to claim 2, the sensor calibrating method comprising a procedure for calibrating the electronic compass and/or the inertia measurement device by, with the attachable-detachable unit removed from the unmanned aerial vehicle, manually rotating the attachable-detachable unit or manually keeping the attachable-detachable unit at a predetermined posture.

10. A sensor calibrating method using the attachable-detachable unit according to claim 3, the sensor calibrating method comprising a procedure for calibrating the electronic compass and/or the inertia measurement device by, with the attachable-detachable unit removed from the unmanned aerial vehicle, manually rotating the attachable-detachable unit or manually keeping the attachable-detachable unit at a predetermined posture.

11. A sensor calibrating method using the attachable-detachable unit according to claim 4, the sensor calibrating method comprising a procedure for calibrating the electronic compass and/or the inertia measurement device by, with the attachable-detachable unit removed from the unmanned aerial vehicle, manually rotating the attachable-detachable unit or manually keeping the attachable-detachable unit at a predetermined posture.

12. A sensor calibrating method using the attachable-detachable unit according to claim 5, the sensor calibrating method comprising a procedure for calibrating the electronic compass and/or the inertia measurement device by, with the attachable-detachable unit removed from the unmanned aerial vehicle, manually rotating the attachable-detachable unit or manually keeping the attachable-detachable unit at a predetermined posture.

13. A sensor calibrating method using the attachable-detachable unit according to claim 6, the sensor calibrating method comprising a procedure for calibrating the electronic compass and/or the inertia measurement device by, with the attachable-detachable unit removed from the unmanned aerial vehicle, manually rotating the attachable-detachable unit or manually keeping the attachable-detachable unit at a predetermined posture.

14. A sensor calibrating method using the attachable-detachable unit according to claim 7, the sensor calibrating method comprising a procedure for calibrating the electronic compass and/or the inertia measurement device by, with the attachable-detachable unit removed from the unmanned aerial vehicle, manually rotating the attachable-detachable unit or manually keeping the attachable-detachable unit at a predetermined posture.
